(19) United States
(12) Patent Application Publication
(10) Pub. No.: US 2009/0128911 A1
(43) Pub. Date: May 21, 2009

(54) Diffraction Grating With a Spatially Varying Duty-Cycle

(76) Inventors: Moti Itzkovitch, Petach-Tikva (IL); Eyal Neistein, RaAnana (IL); Naim Konforti, Holon (IL)

Correspondence Address: MARTIN D. MOYNIHAN d/b/a PRTSI, INC., P.O. BOX 16446, ARLINGTON, VA, 22215, US

(21) Appl. No.: 11/991,492

(22) PCT Filed: Sep. 7, 2006
(86) PCT No.: PCT/IL2006/001051

§ 371 Date: Mar. 5, 2008

Related U.S. Application Data
(63) Continuation of application No. 11/505,866, filed on Aug. 18, 2006.
(60) Provisional application No. 60/716,533, filed on Sep. 14, 2005.
(60) Provisional application No. 60/732,661, filed on Nov. 3, 2005.
(60) Provisional application No. 60/801,410, filed on May 19, 2006.

(51) Int. Cl. G02B 27/44; G02B 5/18

(52) U.S. Cl. 359/575

(57) ABSTRACT

A diffractive optical element is disclosed. The optical element comprises a grating having a periodic linear structure in at least one direction. The linear structure is characterized by non-uniform duty cycle selected to ensure non-uniform diffraction efficiency.

### FIELD AND BACKGROUND OF THE INVENTION

The present invention relates to optics, and, more particularly, to a method device and system for transmitting light at predetermined intensity profile.

Miniaturization of electronic devices has always been a continuing objective in the field of electronics. Electronic devices are often equipped with some form of a display, which is visible to a user. As these devices reduce in size, there is an increase need for manufacturing compact displays, which are compatible with small size electronic devices. Besides having small dimensions, such displays should not sacrifice image quality, and be available at low cost. By definition the above characteristics are conflicting and many attempts have been made to provide some balanced solution.

An electronic display may provide a real image, the size of which is determined by the physical size of the display device, or a virtual image, the size of which may extend the dimensions of the display device.

A real image is defined as an image, projected on or displayed by a viewing surface positioned at the location of the image, and observed by an unaided human eye (to the extent that the viewer does not require corrective glasses). Examples of real image displays include a cathode ray tube (CRT), a liquid crystal display (LCD), an organic light emitting diode array (OLED), or any screen-projected displays. A real image could be viewed normally from a distance of about at least 25 cm, the minimal distance at which the human eye can utilize focus onto an object. Unless a person is long-sighted, he may not be able to view a sharp image at a closer distance.

Typically, desktop computer systems and workplace computing equipment utilize CRT display screens to display images for a user. The CRT displays are heavy, bulky and not easily miniaturized. For a laptop, a notebook, or a palm computer, flat-panel display is typically used. The flat-panel display may use LCD technology implemented as passive matrix or active matrix panel. The passive matrix LCD panel consists of a grid of horizontal and vertical wires. Each intersection of the grid constitutes a single pixel, and controls an LCD element. The LCD element either allows light through or blocks the light. The active matrix panel uses a transistor to control each pixel, and is more expensive.

An OLED flat panel display is an array of light emitting diodes, made of organic polymeric materials. Existing OLED flat panel displays are based on both passive and active configurations. Unlike the LCD display, which controls light transmission or reflection, an OLED display emits light, the intensity of which is controlled by the electrical bias applied thereto. Flat-panels are also used for miniature image display systems because of their compactness and energy efficiency compared to the CRT displays. Small size real image displays have a relatively small surface area on which to present a real image, thus have limited capability for providing sufficient information to the user. In other words, because of the limited resolution of the human eye, the amount of details resolved from a small size real image might be insufficient.

By contrast to a real image, a virtual image is defined as an image, which is not projected onto or emitted from a viewing surface, and no light ray connects the image and an observer. A virtual image can only be seen through an optic element, for example a typical virtual image can be obtained from an object placed in front of a converging lens, between the lens and its focal point. Light rays, which are reflected from an individual point on the object, diverge when passing through the lens, thus no two rays share two endpoints. An observer, viewing from the other side of the lens would perceive an image, which is located behind the object, hence enlarged. A virtual image of an object, positioned at the focal plane of a lens, is said to be projected to infinity. A virtual image display system, which includes a miniature display panel and a lens, can enable viewing of a small size, but high content display, from a distance much smaller than 25 cm. Such a display system can provide a viewing capability which is equivalent to a high content, large size real image display system, viewed from much larger distance.

Conventional virtual image displays are known to have many shortcomings. For example, such displays have suffered from being too heavy for comfortable use, as well as too large so as to be obtrusive, distracting and even disorienting. These defects stem from, inter alia, the incorporation of relatively large optics systems within the mounting structures, as well as physical designs which fail to adequately take into account important factors as size, shape, weight, etc.

Recently, holographic optical elements have been used in portable virtual image displays. Holographic optical elements serve as an imaging lens and a combiner where a two-dimensional, quasi-monochromatic display is imaged to infinity and reflected into the eye of an observer. A common problem to all types of holographic optical elements is their relatively high chromatic dispersion. This is a major drawback in applications where the light source is not purely monochromatic. Another drawback of some of these displays is the lack of coherence between the geometry of the image and the geometry of the holographic optical element, which causes aberrations in the image array that decrease the image quality.

New designs, which typically deal with a single holographic optical element, compensate for the geometric and chromatic aberrations by using non-spherical waves rather than simple spherical waves for recording; however, they do not overcome the chromatic dispersion problem. Moreover, with these designs, the overall optical systems are usually very complicated and difficult to manufacture. Furthermore, the field-of-view resulting from these designs is usually very small.

U.S. Pat. No. 4,711,512 to Upatnieks, the contents of which are hereby incorporated by reference, describes a diffractive planar optics head-up display configured to transmit collimated light wavefronts of an image, as well as to allow light rays coming through the aircraft windscreen to pass and be viewed by the pilot. The light wavefronts enter an elongated optical element located within the aircraft cockpit through a first diffractive element, are diffracted into total internal reflection within the optical element, and are diffracted out of the optical element by means of a second diffractive element into the direction of the pilot's eye while retaining the collimation. Upatnieks, however, does not teach how to control the intensity profile of the optical output.

U.S. Pat. No. 5,966,223 to Friesem et al., the contents of which are hereby incorporated by reference describes a holographic optical device similar to that of Upatnieks, with the additional aspect that the first diffractive optical element acts further as the collimating element that collimates the waves emitted by each data point in a display source and corrects for field aberrations over the entire field-of-view. The field-of-view discussed is ±6°, and there is a further discussion of low chromatic sensitivity over wavelength shift of Δλ_{c} of ±2 nm around a center wavelength λ_{c} of 632.8 nm. However, the diffractive collimating element of Friesem et al. is known to narrow spectral response, and the low chromatic sensitivity at spectral range of ±2 nm becomes an unacceptable sensitivity at ±20 nm or ±70 nm.

U.S. Pat. No. 6,757,105 to Niv et al., the contents of which are hereby incorporated by reference, provides a diffractive optical element for optimizing a field-of-view for a multicolor spectrum. The optical element includes a light-transmissive substrate and a linear grating formed therein. Niv et al. teach how to select the pitch of the linear grating and the refraction index of the light-transmissive substrate so as to trap a light beam having a predetermined spectrum and characterized by a predetermined field of view to propagate within the light-transmissive substrate via total internal reflection. Niv et al. also disclose an optical device incorporating the aforementioned diffractive optical element for transmitting light in general and images in particular into the eye of the user.

A binocular device which employs several diffractive optical elements is disclosed in U.S. patent application Ser. No. 10/896,865 and in International Patent Application, Publication No. WO 2006/008734, the contents of which are hereby incorporated by reference. An optical relay is formed of a light transmissive substrate, an input diffractive optical element and two output diffractive optical elements. Collimated light is diffracted into the optical relay by the input diffractive optical element, propagates in the substrate via total internal reflection and coupled out of the optical relay by two output diffractive optical elements. The input and output diffractive optical elements preserve relative angles of the light rays to allow transmission of images with minimal or no distortions. The output elements are spaced apart such that light diffracted by one element is directed to one eye of the viewer and light diffracted by the other element is directed to the other eye of the viewer.

A common feature of many virtual image devices such as those disclosed by the above references, is the use of light transmissive substrate formed with diffraction gratings for coupling the image into the substrate and transmitting the image to the eyes of the user. The diffraction gratings, and particularly the diffraction gratings which are responsible for diffracting the light out of the substrate, are typically designed such that light rays impinge on the gratings more than one time. This is because the light propagates in the substrate via total internal reflection and once a light ray impinges on the grating, only a part of the ray's energy is diffracted while the other part continues to propagate and to re-impinge on the grating. Thus, light rays experience several partial diffractions where at each such partial diffraction a different portion of the optical energy exits the substrate. As a result, the optical output across the grating is not uniform.

The problem of the non-uniform optical output of diffractive elements is known but heretofore has only been partially addressed.

U.S. Pat. No. 6,833,955 to Niv discloses an optical device having two light-transmissive substrates engaging two parallel planes. The substrates include diffractive optical elements to ensure that the light is expanded in a first dimension within one substrate, and in a second dimension within the other substrate. The efficiency of the diffractive elements varies locally for providing uniform light intensities.

Schechter et al., in an article entitled “Compact Beam Expander with Linear Gratings”, published on 2002 in Applied Optics, 41(7): 1236-40, disclose the variation of the diffraction efficiency across an output grating in a beam expander by varying the modulation depth of the grating.

Additional references of interest include, U.S. Pat. Nos. 5,742,433, 6,369,948, 6,927,915, 4,886,341, 5,367,588, 5,574,597, U.S. Patent Application Nos. 20040021945, 20030123159 and 20060051024, and Japanese Patent No. 90333709.

The present invention provides solutions to the problems associated with prior art diffraction techniques.

### SUMMARY OF THE INVENTION

According to one aspect of the present invention there is provided a diffractive optical element. The optical element comprises a grating having a periodic linear structure in one or more directions. The linear structure is characterized by non-uniform duty cycle selected such that the grating is described by non-uniform diffraction efficiency function.

According to another aspect of the present invention there is provided an optical relay device. The relay device comprises a light transmissive substrate and a plurality of diffractive optical elements, wherein one or more of the diffractive optical elements comprise a grating, and the grating has a periodic linear characterized by the non-uniform duty cycle.

According to still another aspect of the present invention there is provided a system for providing an image to a user. The system comprises the optical relay device, and an image generating system for providing the optical relay device with collimated light constituting the image.

According to a further aspect of the present invention there is provided a method of diffracting light. The method comprises entrapping the light to propagate through a light transmissive substrate via total internal reflection, and using the diffractive optical element for diffracting the light out of the light transmissive substrate.

According to further features in preferred embodiments of the invention described below, the linear structure is further characterized by non-uniform modulation depth selected in combination with the non-uniform duty cycle to provide the non-uniform diffraction efficiency function.

According to still further features in the described preferred embodiments the non-uniform diffraction efficiency function is selected such that when a light ray impinges on the grating a plurality of times, a predetermined and substantially constant fraction of the energy of the light is diffracted at each impingement.

According to still further features in the described preferred embodiments at least one grating is formed in the light transmissive substrate.

According to still further features in the described preferred embodiments at least one grating is attached to the light transmissive substrate.

According to still further features in the described preferred embodiments the plurality of diffractive optical elements of the relay device or system comprises an input diffractive optical element, a first output diffractive optical element and a second output diffractive optical element.

According to still further features in the described preferred embodiments the input diffractive optical element is designed and constructed for diffracting light striking the device at a plurality of angles within a predetermined field-of-view into the substrate. According to still further features in the described preferred embodiments light corresponding to a first partial field-of-view propagates via total internal reflection to impinge on the first output diffractive optical element, and light corresponding to a second partial field-of-view propagates via total internal reflection to impinge on the second output diffractive optical element, where the first partial field-of-view is different from the second partial field-of-view.

According to still further features in the described preferred embodiments the image generating system comprises a light source, at least one image carrier and a collimator for collimating light produced by the light source and reflected or transmitted through the at least one image carrier.

According to still further features in the described preferred embodiments the image generating system comprises at least one miniature display and a collimator for collimating light produced by the at least one miniature display.

According to still further features in the described preferred embodiments the image generating system comprises a light source, configured to produce light modulated imagery data, and a scanning device for scanning the light modulated imagery data onto the optical relay device.

The present invention successfully addresses the shortcomings of the presently known configurations by providing a method device and system for transmitting light at predetermined intensity profile.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of light diffraction by a linear diffraction grating operating in transmission mode;

FIG. 2 is a schematic illustration of a cross-sectional view along the y-z plane of a conventional optical relay device;

FIGS. 3a-b are simplified illustrations of a top view (FIG. 3a) and a side view (FIG. 3b) of diffractive optical element, according to various exemplary embodiments of the invention;

FIG. 4 is a schematic illustration of a grating having a non-uniform duty cycle, according to various exemplary embodiments of the present invention;

FIG. 5 is a schematic illustration of a grating having a non-uniform modulation depth, according to various exemplary embodiments of the present invention;

FIG. 6 is a schematic illustration of a grating having a non-uniform duty cycle and a non-uniform modulation depth, according to various exemplary embodiments of the present invention;

FIG. 7 is a schematic illustration of an optical relay device, according to various exemplary embodiments of the present invention;

FIGS. 8a-b are schematic illustrations of a perspective view (FIG. 8a) and a side view (FIG. 8b) of the optical relay device, in a preferred embodiment in which the device comprises one input optical element and two output optical elements, according to various exemplary embodiments of the present invention;

FIGS. 9a-b are fragmentary views schematically illustrating wavefront propagation within the optical relay device, according to preferred embodiments of the present invention;

FIG. 10 is a schematic illustration of binocular system, according to various exemplary embodiments of the present invention;

FIGS. 11a-c are schematic illustrations of a wearable device, according to various exemplary embodiments of the present invention;

FIGS. 12a-d is a graph showing numerical calculations of the diffraction efficiency of a grating as a function of the duty cycle, for impinging angles of 50° (FIGS. 12a-b) and 55° (FIGS. 12c-d), and modulation depths of 150 nm (FIGS. 12a and 12c) and 300 nm (FIGS. 12b and 12d); and

FIGS. 13a-b is a graph showing numerical calculations of the diffraction efficiency of a grating as a function of the modulation depth, for duty cycle of 0.5 and impinging angles of 50° (FIG. 13a) and 55° (FIG. 13b).

### DESCRIPTION OF THE PREFERRED EMBODIMENTS

The present embodiments comprise a method, device and system which can be used for transmitting light for providing illumination or virtual images. The present embodiments can be used in applications in which virtual images are viewed, including, without limitation, eyeglasses, binoculars, head mounted displays, head-up displays, cellular telephones, personal digital assistants, aircraft cockpits and the like.

The principles and operation of the device, system kit and methods according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

When a ray of light moving within a light-transmissive substrate and striking one of its internal surfaces at an angle φ₁ as measured from a normal to the surface, it can be either reflected from the surface or refracted out of the surface into the open air in contact with the substrate. The condition according to which the light is reflected or refracted is determined by Snell's law, which is mathematically realized through the following equation:

n_{A} sin φ₂=n_{S} sin φ₁, (EQ. 1)

where n_{S} is the index of refraction of the light-transmissive substrate, n_{A} is the index of refraction of the medium outside the light transmissive substrate (n_{S}>n_{A}), and φ₂ is the angle in which the ray is refracted out, in case of refraction. Similarly to φ₁, φ₂ is measured from a normal to the surface. A typical medium outside the light transmissive substrate is air having an index of refraction of about unity.

As used herein, the term “about” refers to ±10%.

As a general rule, the index of refraction of any substrate depends on the specific wavelength λ of the light which strikes its surface. Given the impact angle, φ₁, and the refraction indices, n_{S} and n_{A}, Equation 1 has a solution for φ₂ only for φ₁ which is smaller than arcsine of n_{A}/n_{S} often called the critical angle and denoted φ_{c}. Hence, for sufficiently large φ₁ (above the critical angle), no refraction angle φ₂ satisfies Equation 1 and light energy is trapped within the light-transmissive substrate. In other words, the light is reflected from the internal surface as if it had stroked a mirror. Under these conditions, total internal reflection is said to take place. Since different wavelengths of light (i.e., light of different colors) correspond to different indices of refraction, the condition for total internal reflection depends not only on the angle at which the light strikes the substrate, but also on the wavelength of the light. In other words, an angle which satisfies the total internal reflection condition for one wavelength may not satisfy this condition for a different wavelength.

When a sufficiently small object or sufficiently small opening in an object is placed in the optical path of light, the light experiences a phenomenon called diffraction in which light rays change direction as they pass around the edge of the object or at the opening thereof. The amount of direction change depends on the ratio between the wavelength of the light and the size of the object/opening. In planar optics there is a variety of optical elements which are designed to provide an appropriate condition for diffraction. Such optical elements are typically manufactured as diffraction gratings which are located on a surface of a light-transmissive substrate. Diffraction gratings can operate in transmission mode, in which case the light experiences diffraction by passing through the gratings, or in reflective mode in which case the light experiences diffraction while being reflected off the gratings.

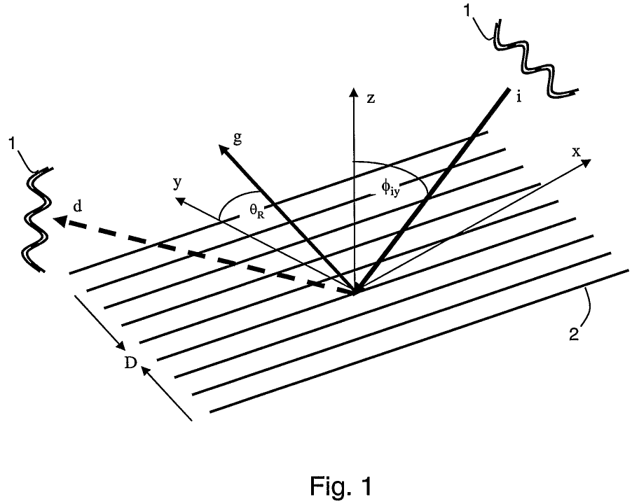

FIG. 1 schematically illustrates diffraction of light by a linear diffraction grating operating in transmission mode. One of ordinary skills in the art, provided with the details described herein would know how to adjust the description for the case of reflection mode.

A wavefront 1 of the light propagates along a vector i and impinges upon a grating 2 engaging the x-y plane. The normal to the grating is therefore along the z direction and the angle of incidence of the light φᵢ is conveniently measured between the vector i and the z axis. In the description below, φᵢ is decomposed into two angles, φᵢₓ and φ_{iy}, where φᵢₓ is the incidence angle in the z-x plane, and φ_{iy} is the incidence angle in the z-y plane. For clarity of presentation, only φ_{iy} is illustrated in FIG. 1.

The grating has a periodic linear structure along a vector g, forming an angle θ_{R} with the y axis. The period of the grating (also known as the grating pitch) is denoted by D. The grating is formed on a light transmissive substrate having an index of refraction denoted by n_{S}.

Following diffraction by grating 2, wavefront 1 changes its direction of propagation. The principal diffraction direction which corresponds to the first order of diffraction is denoted by d and illustrated as a dashed line in FIG. 1. Similarly to the angle of incidence, the angle of diffraction φ_{d}, is measured between the vector d and the z axis, and is decomposed into two angles, φ_{dx} and φ_{dy}, where φ_{dx} is the diffraction angle in the z-x plane, and φ_{dy} is the diffraction angle in the z-y plane.

The relation between the grating vector g, the diffraction vector d and the incident vector i can therefore be expressed in terms of five angles (θ_{R}, φᵢₓ, φ_{iy}, φ_{dx} and φ_{dy}) and it generally depends on the wavelength λ of the light and the grating period D through the following pair of equations:

sin(φᵢₓ)−n_{S} sin(φ_{dx})=(λ/D)sin(θ_{R}) (EQ. 2)

sin(φ_{iy})+n_{S} sin(φ_{dy})=(λ/D)cos(θ_{R}). (EQ. 3)

Without the loss of generality, the Cartesian coordinate system can be selected such that the vector i lies in the y-z plane, hence sin(φᵢₓ)=0. In the special case in which the vector g lies along the y axis, θ_{R}=0° or 180°, and Equations 2-3 reduce to the following one-dimensional grating equation:

sin φ_{iy}+n_{S} sin φ_{dy}=±λ/d. (EQ. 4)

According the known conventions, the sign of φᵢₓ, φ_{iy}, φ_{dx} and φ_{dy} is positive, if the angles are measured clockwise from the normal to the grating, and negative otherwise. The dual sign on the RHS of the one-dimensional grating equation relates to two possible orders of diffraction, +1 and −1, corresponding to diffractions in opposite directions, say, “diffraction to the right” and “diffraction to the left,” respectively.

A light ray, entering a substrate through a grating, impinge on the internal surface of the substrate opposite to the grating at an angle φ_{d} which satisfies sin²(φ_{d})=sin²(φ_{dx})+sin²(φ_{dy}). When φ_{d} is larger than the critical angle α_{c}, the wavefront undergoes total internal reflection and begin to propagate within the substrate.

Diffraction gratings are often formed in a light transmissive substrate to provide an appropriate condition of total internal reflection within the substrate.

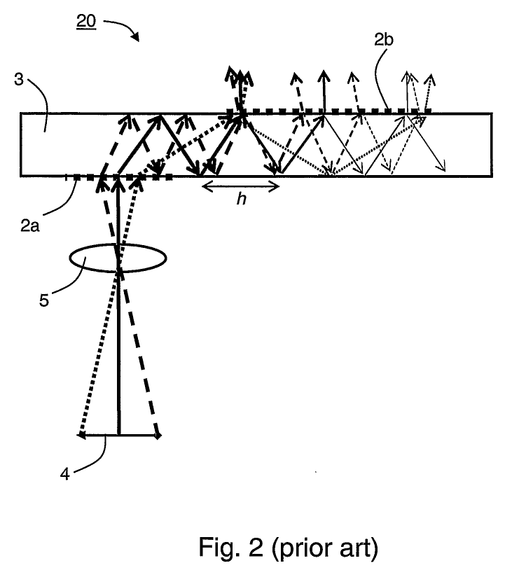

FIG. 2 is a schematic illustration of a cross-sectional view along the y-z plane of a conventional (i.e., prior art) optical relay device 20 having an input grating 2a and an output grating 2b, formed on a light transmissive substrate 3. Light transmissive substrate 3 has generally two surfaces, which are substantially parallel to each other. The principles and operations of gratings 2a and 2b are similar to the principles and operations of grating 2 described above. An object 4 is positioned in front input grating 2a and a converging lens 5 is positioned between object 4 and grating 2a. Object 4 emits light which is collimated by the lens and impinges on grating 2a. For clarity of presentation, FIG. 2 illustrates three principal light rays which are emitted by three different parts of the object and pass through the center of the lens. It should be understood that all light rays emitted from a certain point of the object and pass through the collimating lens comes out of the lens in a substantially parallel direction to the principal light ray emitted by same object point. Thus, all such light rays propagate along a parallel path to that of the principal light ray.

The period of grating 2a is selected such that the diffraction angle of the incident light rays is above the critical angle, and the light propagates in the substrate via total internal reflection.

The available range of incident angles is often referred to in the literature as a “field-of-view.” The input optical element is designed to trap all light rays in the field-of-view within substrate 3. A field-of-view can be expressed either inclusively, in which case its value corresponds to the difference between the minimal and maximal incident angles, or explicitly in which case the field-of-view has a form of a mathematical range or set. Thus, for example, a field-of-view, Ω, spanning from a minimal incident angle, α, to a maximal incident angle, β, is expressed inclusively as Ω=β−α, and exclusively as Ω=[α, β]. The minimal and maximal incident angles are also referred to as rightmost and leftmost incident angles or counterclockwise and clockwise field-of-view angles, in any combination. The inclusive and exclusive representations of the field-of-view are used herein interchangeably.

The propagated light, after a few reflections within substrate 3, reaches grating 2b which diffracts the light out of substrate 3. Diffraction gratings are typically characterized by a diffraction efficiency which is defined as the fraction of light energy being diffracted by the gratings. As shown in FIG. 2, only a portion of the light energy exits substrate 3 by diffraction while the remnant of each ray is further reflected within the substrate. This corresponds to a diffraction efficiency of less than 100%. The remnant of each ray is redirected through an angle, which causes it, again, to experience total internal reflection from the other side of substrate 3. After a first reflection, the remnant may re-strike element 2b, and upon each such re-strike, an additional part of the light energy exits substrate 3. The Euclidian distance between two successive points on the internal surface of the substrate at which a particular light ray experiences total internal reflection is referred to as the “hop length” of the light ray and denoted by “h”.

Thus, a light ray propagating in the substrate via total internal reflection exits the substrate in a form of a series of parallel light rays where the distance between two adjacent light rays in the series is h.

For a uniform diffraction efficiency of the output grating, each light ray of the series exits with a lower intensity compared to the preceding light ray. For example, suppose that the diffraction efficiency of the output grating for a particular wavelength is 50% (meaning that for this wavelength 50% of the light energy is diffracted at each diffraction occurrence). In this case, the first light ray of the series carries 50% of the original energy, the second light ray of the series carries less than 25% of the original energy and so on. This results in a non-uniform light output across the output grating.

The present embodiments successfully provide an optical element with a grating designed to provide a predetermined light profile. Generally, a profile of light refers to an optical characteristic (intensity, phase, wavelength, brightness, hue, saturation, etc.) or a collection of optical characteristics of a light beam.

A light beam is typically described as a plurality of light rays which can be parallel, in which case the light beam is said to be collimated, or non-parallel, in which case the light beam is said to be non-collimated.

A light ray is mathematically described as a one-dimensional mathematical object. As such, a light ray intersects any surface which is not parallel to the light ray at a point. A light beam therefore intersects a surface which is not parallel to the beam at a plurality of points, one point for each light ray of the beam. The profile of light is the optical characteristic of the locus of all such intersecting points. In various exemplary embodiments of the invention the profile comprises the intensity of the light and, optionally, one or more other optical characteristics.

Typically, but not obligatorily, the profile of the light beam is measured at a planar surface which is substantially perpendicular to the propagation direction of the light.

A profile relating to a specific optical characteristic is referred to herein as a specific profile and is termed using the respective characteristic. Thus, the term “intensity profile” refers to the intensity of the locus of all the intersecting points, the term “wavelength profile” refers to the wavelength of the locus of all the intersecting points, and so on.

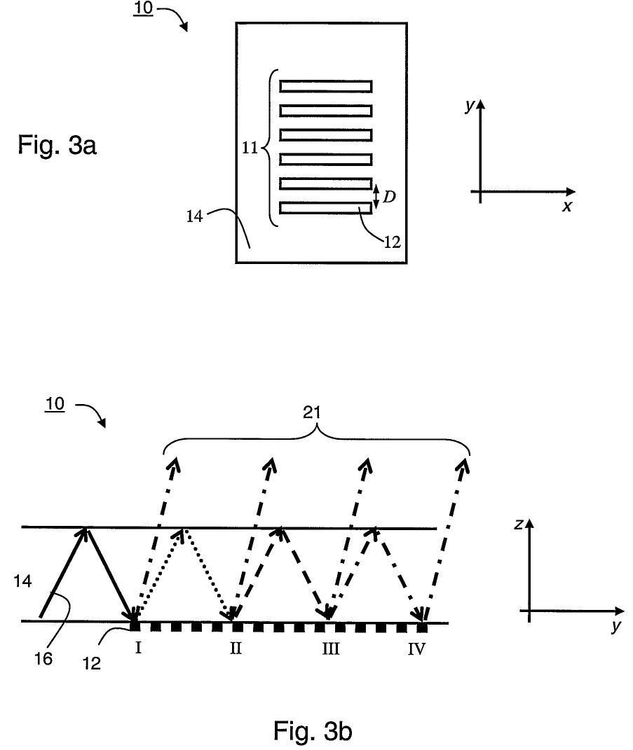

Reference is now made to FIGS. 3a-b which are simplified illustrations of a top view (FIG. 3a) and a side view (FIG. 3b) of diffractive optical element 10, according to various exemplary embodiments of the invention.

Diffraction optical element 10 serves for diffracting light. The term “diffracting” as used herein, refers to a change in the propagation direction of a wavefront, in either a transmission mode or a reflection mode. In a transmission mode, “diffracting” refers to change in the propagation direction of a wavefront while passing through element 10; in a reflection mode, “diffracting” refers to change in the propagation direction of a wavefront while reflecting off element 10 in an angle different from the basic reflection angle (which is identical to the angle of incidence). In the exemplified illustration of FIG. 3b, element 10 operates in a reflective element, i.e., it operates in reflective mode.

Element 10 comprises a grating 12 which can be formed in or attached to a light transmissive substrate 14. Grating 12 has a periodic linear structure 11 in one or more directions. In the representative illustration of FIG. 3a the periodic linear structure is along the y direction. Shown in FIG. 3b is a light ray 16 which propagates within substrate 14 via total internal reflection and impinge on grating 12. Grating 12 diffracts ray 16 out of substrate 14 to provide a light beam 21 having a predetermined profile. Preferably, grating 12 is described by a non-uniform diffraction efficiency function.

The term “non-uniform,” when used in conjunction with a particular observable characterizing the grating (e.g., diffraction efficiency function, duty cycle, modulation depth), refers to variation of the particular observable along at least one direction, and preferably along the same direction as the periodic linear structure (e.g., the y direction in the exemplified illustration of FIG. 3a).

The diffraction efficiency function returns the local diffraction efficiency (i.e., the diffraction efficiency of a particular region) of the grating and can be expressed in terms of percentage relative to the maximal diffraction efficiency of the grating. For example, at a point on the grating at which the diffraction efficiency function returns the value of, say, 50%, the local diffraction efficiency of the grating is 50% of the maximal diffraction efficiency. In various exemplary embodiments of the invention the diffraction efficiency function is a monotonic function over the grating.

The term “monotonic function”, as used herein, has the commonly understood mathematical meaning, namely, a function which is either non-decreasing or non-increasing. Mathematically, a function ƒ(x) is said to be monotonic over the interval [a, b] if ƒ(x₁)≧ƒ(x₂) for any x₁ε[a, b] and x₂ε[a, b] satisfying x₁>x₂, or if ƒ(x₁)≦ƒ(x₂) for any such x₁ and x₂.

In various exemplary embodiments of the invention light beam 21 has a substantially uniform intensity profile for a predetermined range of wavelengths.

As used herein, “substantially uniform intensity profile” refers to an intensity which varies by less than 2% per millimeter, more preferably less than 1% per millimeter.

A “predetermined range of wavelengths” is characterized herein by a central value and an interval. Preferably the predetermined range of wavelengths extends from about 0.7λ to about 1.3λ, more preferably from about 0.85λ to about 1.15λ, where λ is the central value characterizing the range.

Thus, the non-uniform diffraction efficiency function is selected such that when a light ray impinges on grating a plurality of times, a predetermined and substantially constant fraction of the energy of light is diffracted at each impingement.

This can be achieved when the diffraction efficiency function returns a harmonic series (1/k, k=1, 2, . . . ) at the intersection points between the light ray and the grating. In the exemplified embodiment of FIG. 3b ray 16 experiences four diffractions along grating 12. The diffraction points are designated by roman numerals I, II, III and IV. In this example, the diffraction efficiency function preferably returns the value 25% at point I, 33% at point II, 50% at point III and 100% at point IV. For illustrative purposes, reflected light rays of different optical energy are shown in FIG. 3b using different types of lines: solid lines, for light rays carrying 100% of the original optical energy, dotted lines (75%), dashed lines (50%) and dot-dashed lines (25%). Each of the four diffractions thus results in an emission of 25% of the original optical energy of the light ray, and a substantially uniform intensity profile of the light across grating 12 is achieved.

The non-uniform diffraction efficiency function of grating 12 can be achieved in more than one way.

In one embodiment, linear structure 11 of grating 12 is characterized by non-uniform duty cycle selected in accordance with the desired diffraction efficiency function.

As used herein, “duty cycle” is defined as the ratio of the width, W, of a ridge in the grating to the period D.

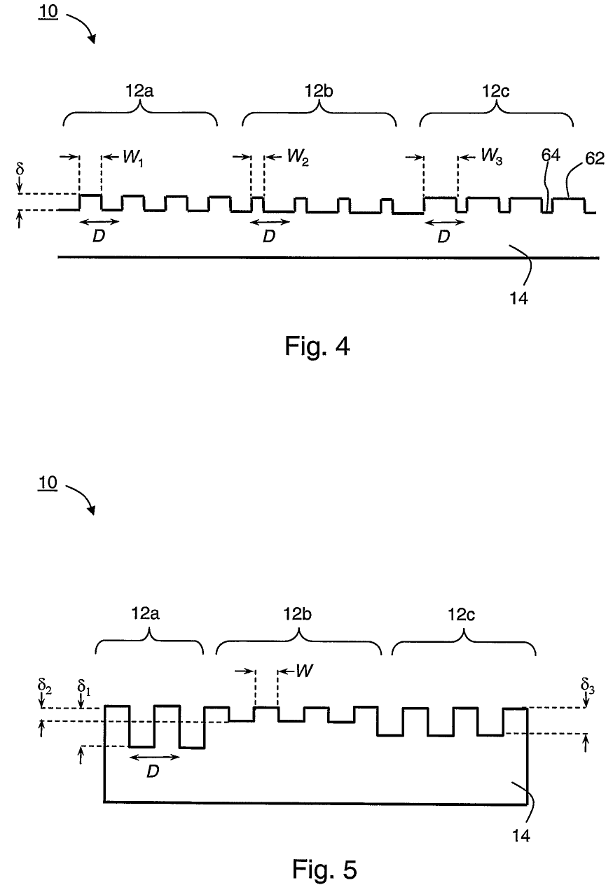

A representative example of element 10 in the preferred embodiment in which grating 12 has non-uniform duty cycle is illustrated in FIG. 4. As shown grating 12 comprises a plurality of ridges 62 and grooves 64. In the exemplified illustration of FIG. 4, the ridges and grooves of the grating form a shape of a square wave. Such grating is referred to as a “binary grating”. Other shapes for the ridges and grooves are also contemplated. Representative examples include, without limitation, triangle, saw tooth and the like.

FIG. 4 exemplifies a preferred embodiment in which grating 12 comprises different sections, where in each section the ridges have a different width. In a first section, designated 12a, the width W₁ of the ridges equals 0.5 D, hence the duty cycle is 0.5; in a second section, designated 12b, the width W₂ of the ridges equals 0.25 D, hence the duty cycle is 0.25; and in a third section, designated 12c, the width W₃ of the ridges equals 0.75 D, hence the duty cycle is 0.75.

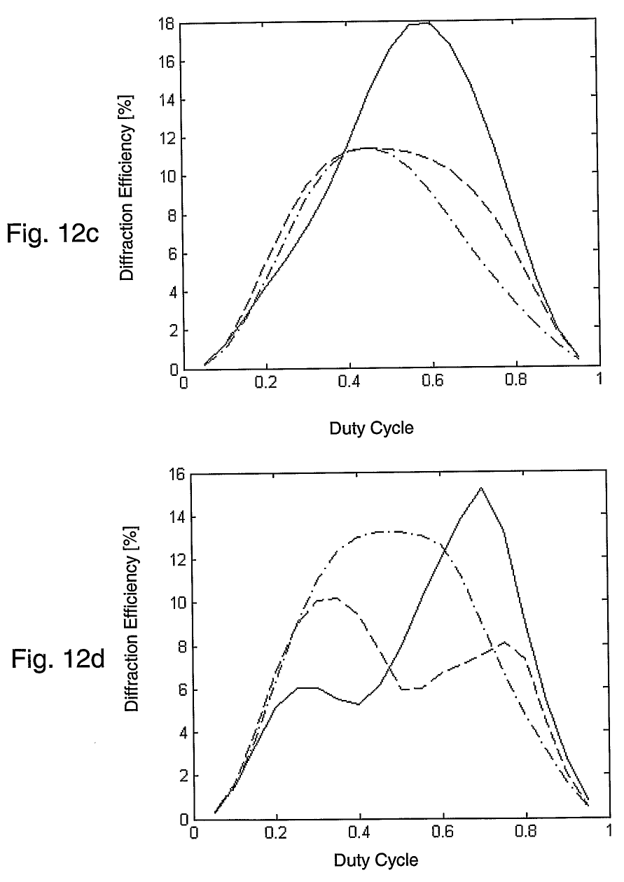

As demonstrated in the Examples section that follows (see FIGS. 12a-d) the diffraction efficiency significantly depends on the value of the duty cycle. Thus, a non-uniform diffraction efficiency function can be achieved using a non-uniform duty cycle. Additionally, FIGS. 12a-d demonstrate that the relation between the diffraction efficiency and the duty cycle depends on the wavelength of the light. By judicious selection of the duty cycle at each region of grating 12, a predetermined profile (intensity, wavelength, etc.) can be obtained.

Linear grating having a non-uniform duty cycle suitable for the present embodiments is preferably fabricated utilizing a technology characterized by a resolution of 50-100 nm. For example, grating 12 can be formed on a light transmissive substrate by employing a process in which electron beam lithography is followed by etching. A process suitable for forming grating having a non-uniform duty cycle according to embodiments of the present invention may be similar to and/or be based on the teachings of U.S. patent application Ser. No. 11/505,866, assigned to the common assignee of the present invention and fully incorporated herein by reference.

An additional embodiment for achieving non-uniform diffraction efficiency function includes a linear structure characterized by non-uniform modulation depth.

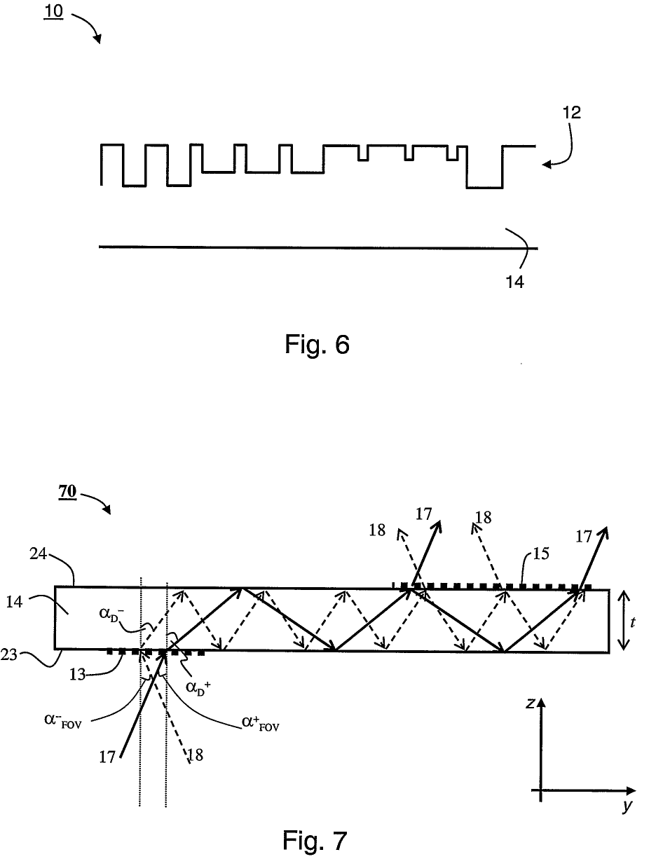

FIG. 5 exemplifies a preferred embodiment in which grating 12 comprises different sections, where in each section the ridges and grooves of grating 12 are characterized by a different modulation depth. The three sections 12a, 12b and 12c have identical duty cycles W/D, but their modulation depths differ. The modulation depth of sections 12a, 12b and 12c are denoted δ₁, δ₂ and δ₃, respectively.

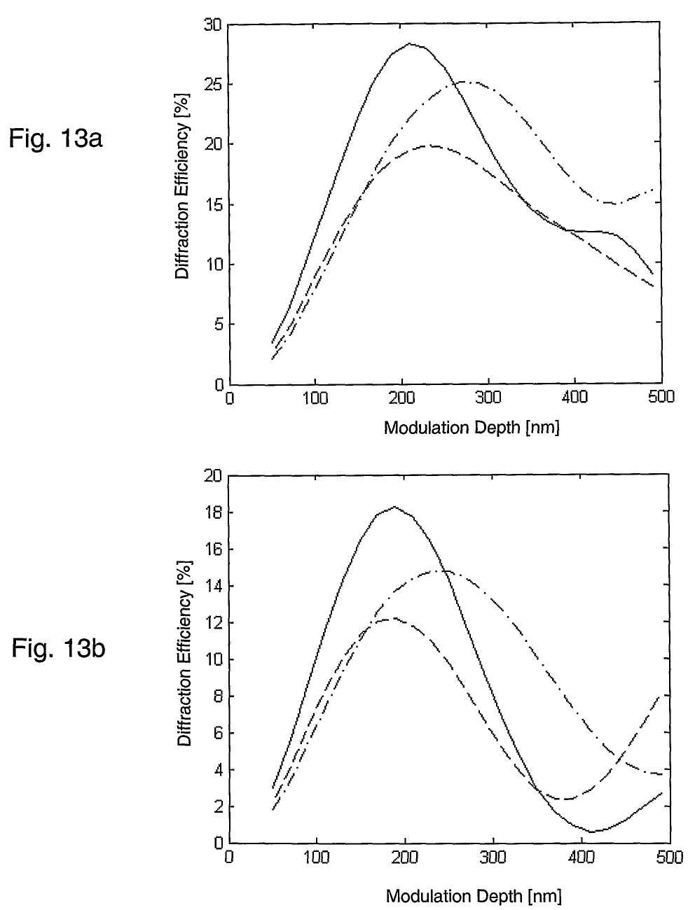

It is demonstrated in the Examples section that follows (see FIGS. 13a-b) that the diffraction efficiency significantly depends on the value of the modulation depth, and that the relation between the diffraction efficiency and the modulation depth depends on the wavelength of the light. A non-uniform diffraction efficiency function can therefore be achieved using a non-uniform modulation depth. By judicious selection of the modulation depth of grating 12 at each region of grating 12, a predetermined profile can be obtained.

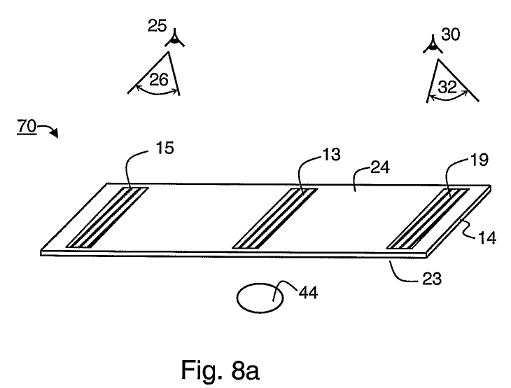

In another embodiment, illustrated in FIG. 6, the linear structure of the grating is characterized by non-uniform modulation depth and non-uniform duty-cycle, where the non-uniform duty cycle is selected in combination with the non-uniform modulation depth to provide the desired non-uniform diffraction efficiency function. As will be appreciated by one ordinarily skilled in the art, the combination between non-uniform duty cycle and non-uniform modulation depth significantly improves the ability to accurately design the grating in accordance with the required profile, because such combination increases the number of degrees of freedom available to the designer.

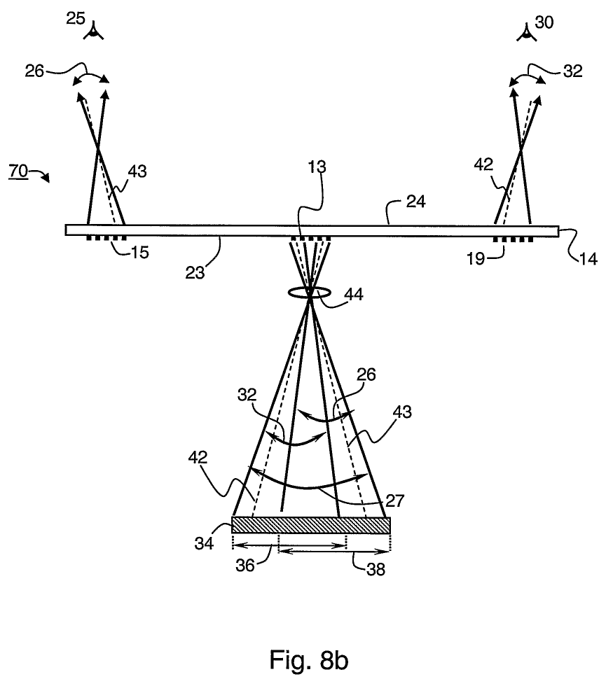

FIG. 7 illustrates an optical device 70, according to various exemplary embodiments of the present invention. Device 70 can serve as an optical relay, and preferably comprises substrate 14, an input optical element 13 and an output optical element 15. Any one of elements 13 and 15 can be made similar to element 10 described above. Elements 13 and 15 can be formed on or attached to any of the surfaces 23 and 24 of substrate 14. Substrate 14 can be made of any light transmissive material, preferably, but not obligatorily a martial having a sufficiently low birefringence.

Element 15 is laterally displaced from element 13 by a few millimeters to a few centimeters. The periodic linear structure of element 13 is preferably substantially parallel to the periodic linear structure of element 15. Device 70 is preferably designed to transmit light striking substrate 14 at any striking angle within a predetermined range of angles, which predetermined range of angles is referred to as the field-of-view of the device.

The field-of-view is illustrated in FIG. 7 by its rightmost light ray 18, striking substrate 14 at an angle α⁻_{FOV}, and leftmost light ray 17, striking substrate 14 at an angle α⁺_{FOV}. α⁻_{FOV} is measured anticlockwise from the normal (parallel to the z axis in FIG. 7) to substrate 14, and α⁺_{FOV} is measured clockwise from the normal. Thus, according to the above convention, α⁻_{FOV} has a negative value and α⁺_{FOV} has a positive value, resulting in a field-of-view of Ω=α⁺_{FOV}+|α⁻_{FOV}|, in inclusive representation.

Input optical element 13 is preferably designed to trap all light rays in the field-of-view within substrate 14. Specifically, when the light rays in the field-of-view impinge on element 13, they are diffracted at a diffraction angle (defined relative to the normal) which is larger than the critical angle, such that upon striking the other surface of substrate 14, all the light rays of the field-of-view experiences total internal reflection and propagate within substrate 14. The diffraction angles of leftmost ray 17 and rightmost ray 18 are designated in FIG. 7 by α_{D}⁺ and α_{D}⁻, respectively. The propagated light, after a few reflections within substrate 14, reaches output optical element 15 which diffracts the light out of substrate 14. As shown in FIG. 7, only a portion of the light energy exits substrate 14. The remnant of each ray is redirected through an angle, which causes it, again, to experience total internal reflection from the other side of substrate 14. After a first reflection, the remnant may re-strike element 15, and upon each such re-strike, an additional part of the light energy exits substrate 14.

The light rays arriving to device 70 can have a plurality of wavelengths, from a shortest wavelength, λ_{B}, to a longest wavelength, λ_{R}, referred to herein as the spectrum of the light. In a preferred embodiment in which surfaces 23 and 24 are substantially parallel, elements 13 and 15 can be designed, for a given spectrum, solely based on the value of α⁻_{FOV} and the value of the shortest wavelength λ_{B}. For example, when the diffractive optical elements are linear gratings, the period, D, of the gratings can be selected based α⁻_{FOV} and λ_{B}, irrespectively of the optical properties of substrate 14 or any wavelength longer than λ_{B}.

According to a preferred embodiment of the present invention D is selected such that the ratio λ_{B}/D is from about 1 to about 2. A preferred expression for D is given by the following equation:

D=λ_{B}/[n_{A}(1−sin α⁻_{FOV})]. (EQ. 5)

It is appreciated that D, as given by Equation 5, is a maximal grating period. Hence, in order to accomplish total internal reflection D can also be smaller than λ_{B}/[n_{A}(1−sin α⁻_{FOV})]

Substrate 14 is preferably selected such as to allow light having any wavelength within the spectrum and any striking angle within the field-of-view to propagate in substrate 14 via total internal reflection.

According to a preferred embodiment of the present invention the refraction index of substrate 14 is larger than λ_{R}/D+n_{A} sin(α⁺_{FOV}). More preferably, the refraction index, n_{S}, of substrate 14 satisfies the following equation:

n_{S}≧[λ_{R}/D+n_{A} sin(α⁺_{FOV})]/sin(α_{D}^{MAX}). (EQ. 6)

where α_{D}^{MAX} is the largest diffraction angle, i.e., the diffraction angle of the light ray which arrive at a striking angle of α⁺_{FOV}. In the exemplified illustration of FIG. 7, α_{D}^{MAX} is the diffraction angle of ray 17. There are no theoretical limitations on α_{D}^{MAX}, except from a requirement that it is positive and smaller than 90 degrees. α_{D}^{MAX} can therefore have any positive value smaller than 90°. Various considerations for the value α_{D}^{MAX} are found in U.S. Pat. No. 6,757,105, the contents of which are hereby incorporated by reference.

The thickness, t, of substrate 14 is preferably from about 0.1 mm to about 5 mm, more preferably from about 1 mm to about 3 mm, even more preferably from about 1 to about 2.5 mm. For multicolor use, t is preferably selected to allow simultaneous propagation of plurality of wavelengths, e.g., t>10 λ_{R}. The width/length of substrate 14 is preferably from about 10 mm to about 100 mm. A typical width/length of the diffractive optical elements depends on the application for which device 70 is used. For example, device 70 can be employed in a near eye display, such as the display described in U.S. Pat. No. 5,966,223, in which case the typical width/length of the diffractive optical elements is from about 5 mm to about 20 mm. The contents of U.S. Patent Application No. 60/716,533, which provides details as to the design of the diffractive optical elements and the selection of their dimensions, are hereby incorporated by reference.

For different viewing applications, such as the application described in U.S. Pat. No. 6,833,955, the contents of which are hereby incorporated by reference, the length of substrate 14 can be 1000 mm or more and the length of diffractive optical element 15 can have a similar size. When the length of the substrate is longer than 100 mm, t is preferably larger than 5 millimeters. This embodiment is advantageous because it reduces the number of hops and maintains the substrate within reasonable structural/mechanical conditions.

Device 70 is capable of transmitting light having a spectrum spanning over at least 100 nm. More specifically, the shortest wavelength, % B, generally corresponds to a blue light having a typical wavelength of between about 400 to about 500 nm and the longest wavelength, λ_{R}, generally corresponds to a red light having a typical wavelength of between about 600 to about 700 nm.

As can be understood from the geometrical configuration illustrated in FIG. 7, the angles at which light rays 18 and 17 diffract can differ. As the diffraction angles depend on the incident angles (see Equations 2-4), the allowed clockwise (α⁺_{FOV}) and anticlockwise (α⁻_{FOV}) field-of-view angles, are also different. Thus, device 70 supports transmission of asymmetric field-of-view in which, say, the clockwise field-of-view angle is greater than the anticlockwise field-of-view angle. The difference between the absolute values of the clockwise and anticlockwise field-of-view angles can reach more than 70% of the total field-of-view.

This asymmetry can be exploited, in accordance with various exemplary embodiments of the present invention, to enlarge the field-of-view of optical device 70. According to a preferred embodiment of the present invention, a light-transmissive substrate can be formed with at least one input optical element and two output optical elements. The input optical element(s) serve for diffracting the light into the light-transmissive substrate in a manner such that different portions of the light, corresponding to different partial fields-of-view, propagate within the substrate in different directions to thereby reach the output optical elements. The output optical elements complementarily diffract the different portions of the light out of the light-transmissive substrate.

The terms “complementarily” or “complementary,” as used herein in conjunction with a particular observable or quantity (e.g., field-of-view, image, spectrum), refer to a combination of two or more overlapping or non-overlapping parts of the observable or quantity so as to provide the information required for substantially reconstructing the original observable or quantity.

Any number of input/output optical elements can be used. Additionally, the number of input optical elements and the number of output optical elements may be different, as two or more output optical elements may share the same input optical element by optically communicating therewith. The input and output optical elements can be formed on a single substrate or a plurality of substrates, as desired. For example, in one embodiment, the input and output optical elements comprise linear diffraction gratings of identical periods, formed on a single substrate, preferably in a parallel orientation.

If several input/output optical elements are formed on the same substrate, as in the above embodiment, they can engage any side of the substrate, in any combination.

One ordinarily skilled in the art would appreciate that this corresponds to any combination of transmissive and reflective optical elements. Thus, for example, suppose that there is one input optical element, formed on surface 23 of substrate 14 and two output optical elements formed on surface 24. Suppose further that the light impinges on surface 23 and it is desired to diffract the light out of surface 24. In this case, the input optical element and the two output optical elements are all transmissive, so as to ensure that entrance of the light through the input optical element, and the exit of the light through the output optical elements. Alternatively, if the input and output optical elements are all formed on surface 23, then the input optical element remain transmissive, so as to ensure the entrance of the light therethrough, while the output optical elements are reflective, so as to reflect the propagating light at an angle which is sufficiently small to couple the light out. In such configuration, light can enter the substrate through the side opposite the input optical element, be diffracted in reflection mode by the input optical element, propagate within the light transmissive substrate in total internal diffraction and be diffracted out by the output optical elements operating in a transmission mode.

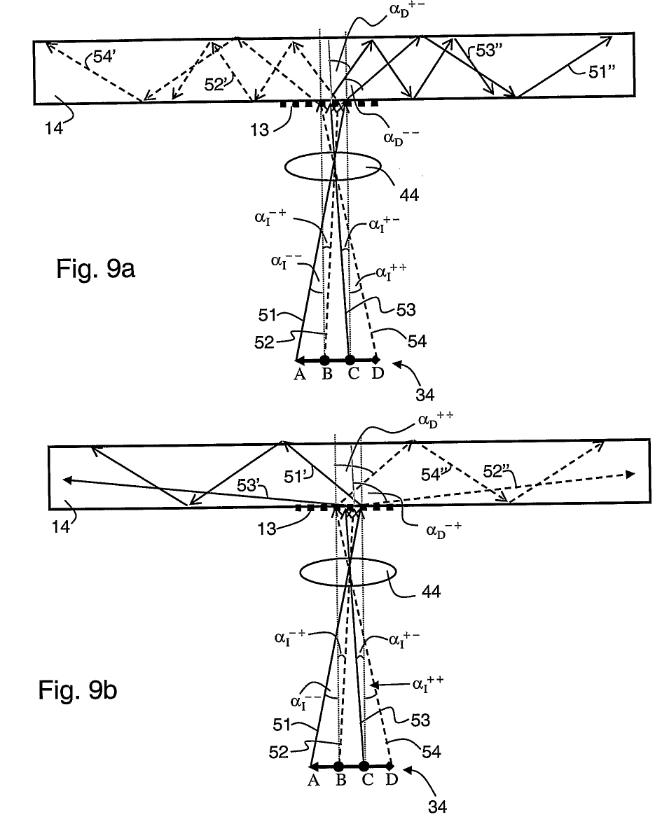

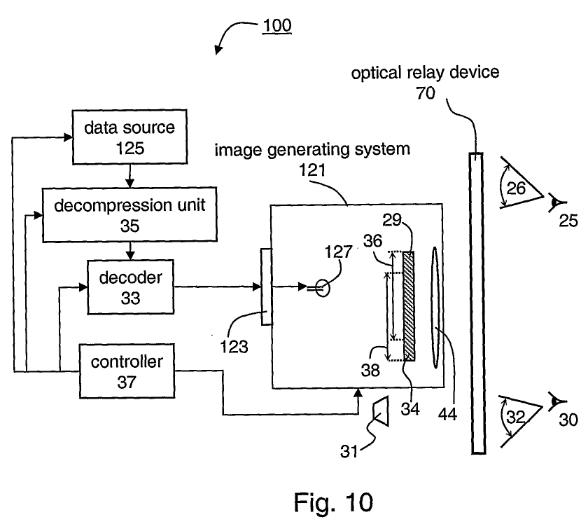

Reference is now made to FIGS. 8a-b which are schematic illustrations of a perspective view (FIG. 8a) and a side view (FIG. 8b) of device 70, in a preferred embodiment in which one input optical element 13 and two output optical elements 15 and 19 are employed. In FIG. 8b, first 15 and second 19 output optical elements are formed, together with input optical element 13, on surface 23 of substrate 14. However, as stated, this need not necessarily be the case, since, for some applications, it may be desired to form the input/output optical elements on any of the surfaces of substrate 14, in an appropriate transmissive/reflective combination. Wavefront propagation within substrate 14, according to various exemplary embodiments of the present invention, is further detailed hereinunder with reference to FIGS. 9a-b.

Element 13 preferably diffracts the incoming light into substrate 14 in a manner such that different portions of the light, corresponding to different partial fields-of-view, propagate in different directions within substrate 14. In the configuration exemplified in FIGS. 8a-b, element 13 diffract light rays within one asymmetric partial field-of-view, designated by reference numeral 26, leftwards to impinge on element 15, and another asymmetric partial field-of-view, designated by reference numeral 32, to impinge on element 19. Elements 15 and 19 complementarily diffract the respective portions of the light, or portions thereof, out of substrate 14, to provide a first eye 25 with partial field-of-view 26 and a second eye 30 with partial field-of-view 32.

Partial fields-of-view 26 and 32 form together the field-of-view 27 of device 70. When device 70 is used for transmitting an image 34, field-of-view 27 preferably includes substantially all light rays originated from image 34. Partial fields-of-view 26 and 32 can correspond to different parts of image 34, which different parts are designated in FIG. 8b by numerals 36 and 38. Thus, as shown in FIG. 8b, there is at least one light ray 42 which enters device 70 via element 13 and exits device 70 via element 19 but not via element 15. Similarly, there is at least one light ray 43 which enters device 70 via element 13 and exits device 70 via element 15 but not via element 19.

Generally, the partial field-of-views, hence also the parts of the image arriving to each eye depend on the wavelength of the light. Therefore, it is not intended to limit the scope of the present embodiments to a configuration in which part 36 is viewed by eye 25 and part 38 viewed by eye 30. In other words, for different wavelengths, part 36 is viewed by eye 30 and part 38 viewed by eye 25. For example, suppose that the image is constituted by a light having three colors: red, green and blue. As demonstrated in the Examples section that follows, device 70 can be constructed such that eye 25 sees part 38 for the blue light and part 36 for the red light, while eye 30 sees part 36 for the blue light and part 38 for the red light. In such configuration, both eyes see an almost symmetric field-of-view for the green light. Thus, for every color, the two partial fields-of-view compliment each other.

The human visual system is known to possess a physiological mechanism capable of inferring a complete image based on several parts thereof, provided sufficient information reaches the retinas. This physiological mechanism operates on monochromatic as well as chromatic information received from the rod cells and cone cells of the retinas. Thus, in a cumulative nature, the two asymmetric field-of-views, reaching each individual eye, form a combined field-of-view perceived by the user, which combined field-of-view is wider than each individual asymmetric field-of-view.

According to a preferred embodiment of the present invention, there is a predetermined overlap between first 26 and second 32 partial fields-of-view, which overlap allows the user's visual system to combine parts 36 and 38 of image 34, thereby to perceive the image, as if it has been fully observed by each individual eye.

For example, as further demonstrated in the Examples section that follows, the diffractive optical elements can be constructed such that the exclusive representations of partial fields-of-view 26 and 32 are, respectively, [−α, β] and [−β, α], resulting in a symmetric combined field-of-view 27 of [−β, β]. It will be appreciated that when β>>α>0, the combined field-of-view is considerably wider than each of the asymmetric field-of-views. Device 70 is capable of transmitting a field-of-view of at least 20 degrees, more preferably at least 30 degrees most preferably at least 40 degrees, in inclusive representation.

When the image is a multicolor image having a spectrum of wavelengths, different sub-spectra correspond to different, wavelength-dependent, asymmetric partial field-of-views, which, in different combinations, form different wavelength-dependent combined fields-of-view. For example, a red light can correspond to a first red asymmetric partial field-of-view, and a second red asymmetric partial field-of-view, which combine to a red combined field-of-view. Similarly, a blue light can correspond to a first blue asymmetric partial field-of-view, and a second blue asymmetric partial field-of-view, which combine to a blue combined field-of-view, and so on. Thus, a multicolor configuration is characterized by a plurality of wavelength-dependent combined field-of-views. According to a preferred embodiment of the present invention the diffractive optical elements are designed and constructed so as to maximize the overlap between two or more of the wavelength-dependent combined field-of-views.

In terms of spectral coverage, the design of device 70 is preferably as follows: element 15 provides eye 25 with, say, a first sub-spectrum which originates from part 36 of image 34, and a second sub-spectrum which originates from part 38 of image 34. Element 19 preferably provides the complementary information, so as to allow the aforementioned physiological mechanism to infer the complete spectrum of the image. Thus, element 19 preferably provides eye 30 with the first sub-spectrum originating from part 38, and the second sub-spectrum originating from part 36.

Ideally, a multicolor image is a spectrum as a function of wavelength, measured at a plurality of image elements. This ideal input, however, is rarely attainable in practical systems. Therefore, the present embodiment also addresses other forms of imagery information. A large percentage of the visible spectrum (color gamut) can be represented by mixing red, green, and blue colored light in various proportions, while different intensities provide different saturation levels. Sometimes, other colors are used in addition to red, green and blue, in order to increase the color gamut. In other cases, different combinations of colored light are used in order to represent certain partial spectral ranges within the human visible spectrum.

In a different form of color imagery, a wide-spectrum light source is used, with the imagery information provided by the use of color filters. The most common such system is using white light source with cyan, magenta and yellow filters, including a complimentary black filter. The use of these filters could provide representation of spectral range or color gamut similar to the one that uses red, green and blue light sources, while saturation levels are attained through the use of different optical absorptive thickness for these filters, providing the well known “grey levels.”

Thus, the multicolored image can be displayed by three or more channels, such as, but not limited to, Red-Green-Blue (RGB) or Cyan-Magenta-Yellow-Black (CMYK) channels. RGB channels are typically used for active display systems (e.g., CRT or OLED) or light shutter systems (e.g., Digital Light Processing™ (DLP™) or LCD illuminated with RGB light sources such as LEDs). CMYK images are typically used for passive display systems (e.g., print). Other forms are also contemplated within the scope of the present invention.

When the multicolor image is formed from a discrete number of colors (e.g., an RGB display), the sub-spectra can be discrete values of wavelength. For example, a multicolor image can be provided by an OLED array having red, green and blue organic diodes (or white diodes used with red, green and blue filters) which are viewed by the eye as continues spectrum of colors due to many different combinations of relative proportions of intensities between the wavelengths of light emitted thereby. For such images, the first and the second sub-spectra can correspond to the wavelengths emitted by two of the blue, green and red diodes of the OLED array, for example the blue and red. Device 70 can be constructed such that, say, eye 30 is provided with blue light from part 36 and red light from part 38 whereas eye 25 is provided with red light from part 36 and blue light from part 38, such that the entire spectral range of the image is transmitted into the two eyes and the physiological mechanism reconstructs the image.

The light arriving at the input optical element of device 70 is preferably collimated. In case the light is not collimated, a collimator 44 can be positioned on the light path between image 34 and the input element.

Collimator 44 can be, for example, a converging lens (spherical or non spherical), an arrangement of lenses and the like. Collimator 44 can also be a diffractive optical element, which may be spaced apart, carried by or formed in substrate 14. A diffractive collimator may be positioned either on the entry surface of substrate 14, as a transmissive diffractive element or on the opposite surface as a reflective diffractive element.

Following is a description of the principles and operations of optical device 70, in the embodiment in which device 70 comprises one input optical element and two output optical elements.

Reference is now made to FIGS. 9a-b which are schematic illustrations of wavefront propagation within substrate 14, according to preferred embodiments of the present invention. Shown in FIGS. 9a-b are four principal light rays, 51, 52, 53 and 54, respectively emitted from four points, A, B, C and D, of image 34. The incident angles, relative to the normal to substrate, of rays 51, 52, 53 and 54 are denoted α_{I}⁻⁻, α_{I}⁻⁺, α_{I}⁺⁻ and α_{I}⁺⁺, respectively. As will be appreciated by one of ordinary skill in the art, the first superscript index refer to the position of the respective ray relative to the center of the field-of-view, and the second superscript index refer to the position of the respective ray relative to the normal from which the angle is measured, according to the aforementioned sign convention.

It is to be understood that this sign convention cannot be considered as limiting, and that one ordinarily skilled in the art can easily practice the present invention employing an alternative convention.

Similar notations will be used below for the diffraction angles of the rays, with the subscript D replacing the subscript L Denoting the superscript indices by a pair i, j, an incident angle is denoted generally as α_{I}^{ij}, and a diffraction angle is denoted generally as α_{D}^{ij}, where ij=“−−”, “−+”, “+−” or “−−”. The relation between each incident angle, α_{I}^{ij}, and its respective diffraction angle, α_{D}^{ij}, is given by Equation 4, above, with the replacements φ_{iy}→α_{I}^{ij}, and φ_{dy}→α_{D}^{ij}.

Points A and D represent the left end and the right end of image 34, and points B and C are located between points A and D. Thus, rays 51 and 53 are the leftmost and the rightmost light rays of a first asymmetric field-of-view, corresponding to a part A-C of image 34, and rays 52 and 54 are the leftmost and the rightmost light rays of a second asymmetric field-of-view corresponding to a part B-D of image 34. In angular notation, the first and second asymmetric field-of-view are, respectively, [α_{I}⁻⁻, α_{I}⁺⁻] and [α_{I}⁻⁺, α_{I}⁺⁺] (exclusive representations). Note that an overlap field-of-view between the two asymmetric field-of-views is defined between rays 52 and 53, which overlap equals [α_{I}⁻⁺, α_{I}⁺⁻] and corresponds to an overlap B-C between parts A-C and B-D of image 34.

In the configuration shown in FIGS. 9a-b, lens 45 magnifies image 34 and collimates the wavefronts emanating therefrom. For example, light rays 51-54 pass through a center of lens 45, impinge on substrate 14 at angles α_{I}^{ij} and diffracted by input optical element 13 into substrate 14 at angles α_{D}^{ij}. For the purpose of a better understanding of the illustrations in FIGS. 9a-b, only two of the four diffraction angles (to each side) are shown in each figure, where FIG. 9a shows the diffraction angles to the right of rays 51 and 53 (angles α_{D}⁺⁻ and α_{D}⁻⁻), and FIG. 9b shows the diffraction angles to the right of rays 52 and 54 (angles α_{D}⁻⁺ and α_{D}⁺⁺).

Each diffracted light ray experiences a total internal reflection upon impinging on the inner surfaces of substrate 14 if |α_{D}^{ij}|, the absolute value of the diffraction angle, is larger than the critical angle α_{c}. Light rays with |α_{D}^{ij}|<α_{c} do not experience a total internal reflection hence escape from substrate 14. Generally, because input optical element 13 diffracts the light both to the left and to the right, a light ray may, in principle, split into two secondary rays each propagating in an opposite direction within substrate 14, provided the diffraction angle of each of the two secondary rays is larger than ac. To ease the understanding of the illustrations in FIGS. 9a-b, secondary rays diffracting leftward and rightward are designated by a single and double prime, respectively.

Reference is now made to FIG. 9a showing a particular and preferred embodiment in which |α_{D}⁻⁺|=|α_{D}⁺⁻|=α_{c}. Shown in FIG. 9a are rightward propagating rays 51″ and 53″, and leftward propagating rays 52′ and 54′. Hence, in this embodiment, element 13 split all light rays between ray 51 and ray 52 into two secondary rays, a left secondary ray, impinging on the inner surface of substrate 14 at an angle which is smaller than α_{c}, and a right secondary ray, impinging on the inner surface of substrate 14 at an angle which is larger than α_{c}. Thus, light rays between ray 51 and ray 52 can only propagate rightward within substrate 14. Similarly, light rays between ray 53 and ray 54 can only propagate leftward. On the other hand, light rays between rays 52 and 53, corresponding to the overlap between the asymmetric field-of-views, propagate in both directions, because element 13 split each such ray into two secondary rays, both impinging the inner surface of substrate 14 at an angle larger than the critical angle, α_{c}.

Thus, light rays of the asymmetrical field-of-view defined between rays 51 and 53 propagate within substrate 14 to thereby reach second output optical element 19 (not shown in FIG. 9a), and light rays of the asymmetrical field-of-view defined between rays 52 and 54 propagate within substrate 14 to thereby reach first output optical element 15 (not shown in FIG. 9a).

In another embodiment, illustrated in FIG. 9b, the light rays at the largest entry angle split into two secondary rays, both with a diffraction angle which is larger than α_{c}, hence do not escape from substrate 14. However, whereas one secondary ray experience a few reflections within substrate 14, and thus successfully reaches its respective output optical element (not shown), the diffraction angle of the other secondary ray is too large for the secondary ray to impinge the other side of substrate 14, so as to properly propagate therein and reach its respective output optical element.

Specifically shown in FIG. 9b are original rays 51, 52, 53 and 54 and secondary rays 51′, 52″, 53′ and 54″. Ray 54 splits into two secondary rays, ray 54′ (not shown) and ray 54″ diffracting leftward and rightward, respectively. However, whereas rightward propagating ray 54″ diffracted at an angle α_{D}⁺⁺ experiences a few reflection within substrate 14 (see FIG. 9b), leftward propagating ray 54′ either diffracts at an angle which is too large to successfully reach element 15, or evanesces.

Similarly, ray 52 splits into two secondary rays, 52′ (not shown) and 52″ diffracting leftward and rightward, respectively. For example, rightward propagating ray 52″ diffracts at an angle α_{D}⁻⁺>α_{c}. Both secondary rays diffract at an angle which is larger than α_{c}, experience one or a few reflections within substrate 14 and reach output optical element 15 and 19 respectively (not shown). In the case that α_{D}⁻⁺ is the largest angle for which the diffracted light ray will successfully reach the optical output element 19, all light rays emitted from part A-B of the image do not reach element 19 and all light rays emitted from part B-D successfully reach element 19. Similarly, if angle α_{D}⁺⁻ is the largest angle (in absolute value) for which the diffracted light ray will successfully reach optical output element 15, then all light rays emitted from part C-D of the image do not reach element 15 and all light rays emitted from part A-C successfully reach element 15.

Thus, light rays of the asymmetrical field-of-view defined between rays 51 and 53 propagate within substrate 14 to thereby reach output optical element 15, and light rays of the asymmetrical field-of-view defined between rays 52 and 54 propagate within substrate 14 to thereby reach output optical element 19.

Any of the above embodiments can be successfully implemented by a judicious design of the monocular devices, and, more specifically the input/output optical elements and the substrate.

For example, as stated, the input and output optical elements can be linear diffraction gratings having identical periods and being in a parallel orientation. This embodiment is advantageous because it is angle-preserving. Specifically, the identical periods and parallelism of the linear gratings ensure that the relative orientation between light rays exiting the substrate is similar to their relative orientation before the impingement on the input optical element. Consequently, light rays emanating from a particular point of the overlap part B-C of image 34, hence reaching both eyes, are parallel to each other. Thus, such light rays can be viewed by both eyes as arriving from the same angle in space. It will be appreciated that with such configuration viewing convergence is easily obtained without eye-strain or any other inconvenience to the viewer, unlike the prior art binocular devices in which relative positioning and/or relative alignment of the optical elements is necessary.

According to a preferred embodiment of the present invention the period, D, of the gratings and/or the refraction index, n_{S}, of the substrate can be selected so to provide the two asymmetrical field-of-views, while ensuring a predetermined overlap therebetween. This can be achieved in more than one way.

Hence, in one embodiment, a ratio between the wavelength, λ, of the light and the period D is larger than or equal a unity:

λ/D≧1. (EQ. 7)

This embodiment can be used to provide an optical device operating according to the aforementioned principle in which there is no mixing between light rays of the non-overlapping parts of the field-of-view (see FIG. 9a).

In another embodiment, the ratio λ/D is smaller than the refraction index, n_{S}, of the substrate. More specifically, D and n_{S} can be selected to comply with the following inequality:

D>λ(n_{S}p), (EQ. 8)

where p is a predetermined parameter which is smaller than 1.

The value of p is preferably selected so as to ensure operation of the device according to the principle in which some mixing is allowed between light rays of the non-overlapping parts of the field-of-view, as further detailed hereinabove (see FIG. 9b). This can be done for example, by setting p=sin(α_{D}^{MAX}), where (α_{D}^{MAX}) is a maximal diffraction angle. Because there are generally no theoretical limitations on α_{D}^{MAX} (apart from a requirement that its absolute value is smaller than 90°), it may be selected according to any practical considerations, such as cost, availability or geometrical limitations which may be imposed by a certain miniaturization necessity. Hence, in one embodiment, further referred to herein as the “at least one hop” embodiment, α_{D}^{MAX} is selected so as to allow at least one reflection within a predetermined distance x which may vary from about 30 mm to about 80 mm.

For example, for a glass substrate, with an index of refraction of n_{S}=1.5 and a thickness of 2 mm, a single total internal reflection event of a light having a wavelength of 465 nm within a distance x of 34 mm, corresponds to α_{D}^{MAX}=83.3°.

In another embodiment, further referred to herein as the “flat” embodiment, α_{D}^{MAX} is selected so as to reduce the number of reflection events within the substrate, e.g. by imposing a requirement that all the diffraction angles will be sufficiently small, say, below 80°.

In an additional embodiment, particularly applicable to those situations in the industry in which the refraction index of the substrate is already known (for example when device 70 is intended to operate synchronically with a given device which includes a specific substrate), Equation 8 may be inverted to obtain the value of p hence also the value of α_{D}^{MAX}=sin⁻¹p.

As stated, device 70 can transmit light having a plurality of wavelengths. According to a preferred embodiment of the present invention, for a multicolor image the gratings period is preferably selected to comply with Equation 7, for the shortest wavelength, and with Equation 8, for the longest wavelength. Specifically:

λ_{R}/(n_{S}p)≦D≦λ_{B}, (EQ. 9)

where λ_{B} and λ_{R} are, respectively, the shortest and longest wavelengths of the multicolor spectrum. Note that it follows from Equation 7 that the index of refraction of the substrate should satisfy, under these conditions, n_{S} p≧λ_{R}/λ_{B}.

The grating period can also be smaller than the sum λ_{B}+λ_{R}, for example:

$$D = \frac{{λ}_{B} + {λ}_{R}}{{n}_{S} sin ( {α}_{D}^{MAX} ) + {n}_{A}} . \qquad ( EQ . 10 )$$

According to an additional aspect of the present invention there is provided a system 100 for providing an image to a user in a wide field-of-view.

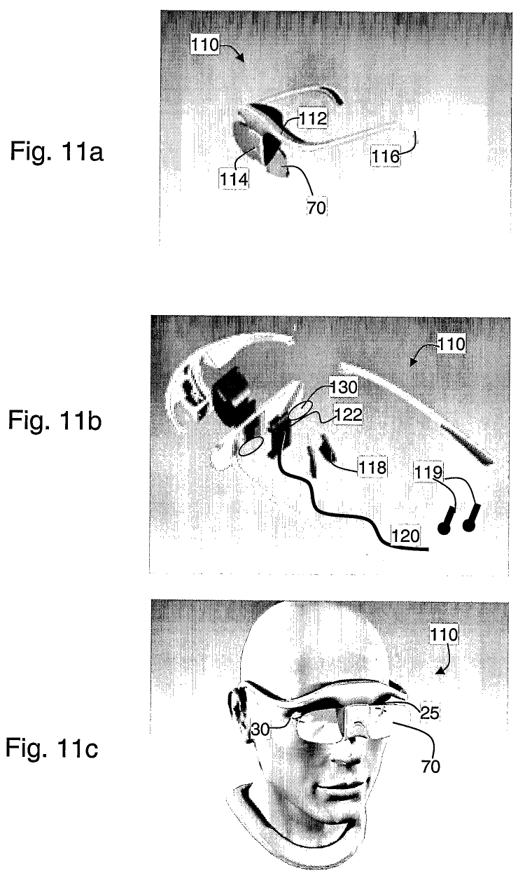

Reference is now made to FIG. 10 which is a schematic illustration of system 100, which, in its simplest configuration, comprises optical relay device 70 for transmitting image 34 into first eye 25 and second eye 30 of the user, and an image generating system 121 for providing optical relay device 70 with collimated light constituting the image.

Image generating system 121 can be either analog or digital. An analog image generating system typically comprises a light source 127, at least one image carrier 29 and a collimator 44. Collimator 44 serves for collimating the input light, if it is not already collimated, prior to impinging on substrate 14. In the schematic illustration of FIG. 10, collimator 44 is illustrated as integrated within system 121, however, this need not necessarily be the case since, for some applications, it may be desired to have collimator 44 as a separate element. Thus, system 121 can be formed of two or more separate units. For example, one unit can comprise the light source and the image carrier, and the other unit can comprise the collimator. Collimator 44 is positioned on the light path between the image carrier and the input element of device 70.

Any collimating element known in the art may be used as collimator 44, for example a converging lens (spherical or non spherical), an arrangement of lenses, a diffractive optical element and the like. The purpose of the collimating procedure is for improving the imaging ability.

In case of a converging lens, a light ray going through a typical converging lens that is normal to the lens and passes through its center, defines the optical axis. The bundle of rays passing through the lens cluster about this axis and may be well imaged by the lens, for example, if the source of the light is located as the focal plane of the lens, the image constituted by the light is projected to infinity.

Other collimating means, e.g., a diffractive optical element, may also provide imaging functionality, although for such means the optical axis is not well defined. The advantage of a converging lens is due to its symmetry about the optical axis, whereas the advantage of a diffractive optical element is due to its compactness.

Representative examples for light source 127 include, without limitation, a lamp (incandescent or fluorescent), one or more LEDs or OLEDs, and the like. Representative examples for image carrier 29 include, without limitation, a miniature slide, a reflective or transparent microfilm and a hologram. The light source can be positioned either in front of the image carrier (to allow reflection of light therefrom) or behind the image carrier (to allow transmission of light therethrough). Optionally and preferably, system 121 comprises a miniature CRT. Miniature CRTs are known in the art and are commercially available, for example, from Kaiser Electronics, a Rockwell Collins business, of San Jose, Calif.

A digital image generating system typically comprises at least one display and a collimator. The use of certain displays may require, in addition, the use of a light source. In the embodiments in which system 121 is formed of two or more separate units, one unit can comprise the display and light source, and the other unit can comprise the collimator.

Light sources suitable for a digital image generating system include, without limitation, a lamp (incandescent or fluorescent), one or more LEDs (e.g., red, green and blue LEDs) or OLEDs, and the like. Suitable displays include, without limitation, rear-illuminated transmissive or front-illuminated reflective LCD, OLED arrays, Digital Light Processing™ (DLP™) units, miniature plasma display, and the like. A positive display, such as OLED or miniature plasma display, may not require the use of additional light source for illumination. Transparent miniature LCDs are commercially available, for example, from Kopin Corporation, Taunton, Mass. Reflective LCDs are are commercially available, for example, from Brillian Corporation, Tempe, Ariz. Miniature OLED arrays are commercially available, for example, from eMagin Corporation, Hopewell Junction, N.Y. DLP™ units are commercially available, for example, from Texas Instruments DLP™ Products, Plano, Tex. The pixel resolution of the digital miniature displays varies from QVGA (320×240 pixels) or smaller, to WQUXGA (3840×2400 pixels).

System 100 is particularly useful for enlarging a field-of-view of devices having relatively small screens. For example, cellular phones and personal digital assistants (PDAs) are known to have rather small on-board displays. PDAs are also known as Pocket PC, such as the trade name iPAQ™ manufactured by Hewlett-Packard Company, Palo Alto, Calif. The above devices, although capable of storing and downloading a substantial amount of information in a form of single frames or moving images, fail to provide the user with sufficient field-of-view due to their small size displays.

Thus, according to a preferred embodiment of the present invention system 100 comprises a data source 125 which can communicate with system 121 via a data source interface 123. Any type of communication can be established between interface 123 and data source 125, including, without limitation, wired communication, wireless communication, optical communication or any combination thereof. Interface 123 is preferably configured to receive a stream of imagery data (e.g., video, graphics, etc.) from data source 125 and to input the data into system 121. Many types or data sources are contemplated. According to a preferred embodiment of the present invention data source 125 is a communication device, such as, but not limited to, a cellular telephone, a personal digital assistant and a portable computer (laptop). Additional examples for data source 125 include, without limitation, television apparatus, portable television device, satellite receiver, video cassette recorder, digital versatile disc (DVD) player, digital moving picture player (e.g., MP4 player), digital camera, video graphic array (VGA) card, and many medical imaging apparatus, e.g., ultrasound imaging apparatus, digital X-ray apparatus (e.g., for computed tomography) and magnetic resonance imaging apparatus.

In addition to the imagery information, data source 125 may generates also audio information. The audio information can be received by interface 123 and provided to the user, using an audio unit 31 (speaker, one or more earphones, etc.).

According to various exemplary embodiments of the present invention, data source 125 provides the stream of data in an encoded and/or compressed form. In these embodiments, system 100 further comprises a decoder 33 and/or a decompression unit 35 for decoding and/or decompressing the stream of data to a format which can be recognized by system 121. Decoder 33 and decompression unit 35 can be supplied as two separate units or an integrated unit as desired.

System 100 preferably comprises a controller 37 for controlling the functionality of system 121 and, optionally and preferably, the information transfer between data source 125 and system 121. Controller 37 can control any of the display characteristics of system 121, such as, but not limited to, brightness, hue, contrast, pixel resolution and the like. Additionally, controller 37 can transmit signals to data source 125 for controlling its operation. More specifically, controller 37 can activate, deactivate and select the operation mode of data source 125. For example, when data source 125 is a television apparatus or being in communication with a broadcasting station, controller 37 can select the displayed channel; when data source 125 is a DVD or MP4 player, controller 37 can select the track from which the stream of data is read; when audio information is transmitted, controller 37 can control the volume of audio unit 31 and/or data source 125.

System 100 or a portion thereof (e.g., device 70) can be integrated with a wearable device, such as, but not limited to, a helmet or spectacles, to allow the user to view the image, preferably without having to hold optical relay device 70 by hand.

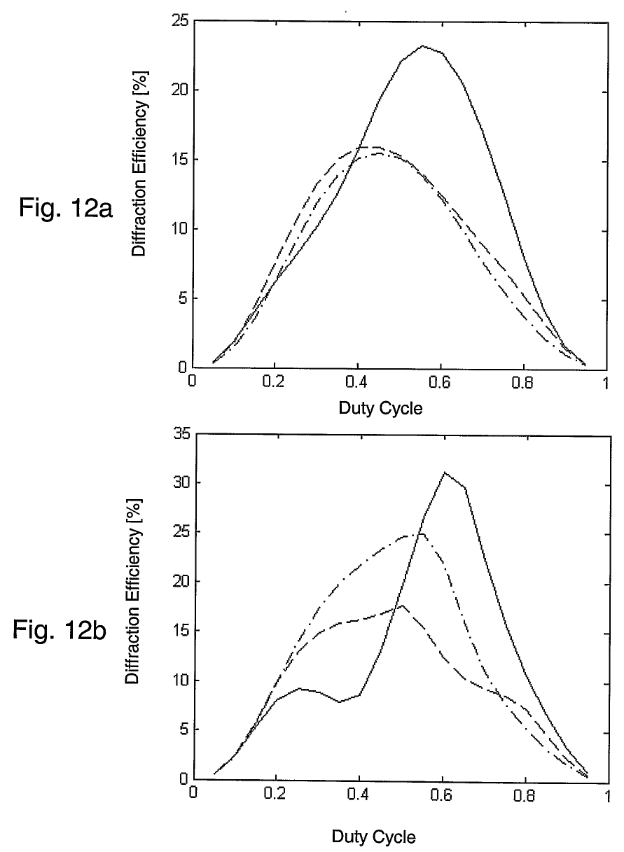

Device 70 can also be used in combination with a vision correction device 130 (not shown, see FIG. 11), for example, one or more corrective lenses for correcting, e.g., short-sightedness (myopia). In this embodiment, the vision correction device is preferably positioned between the eyes and device 20. According to a preferred embodiment of the present invention system 100 further comprises correction device 130, integrated with or mounted on device 70.

Alternatively system 100 or a portion thereof can be adapted to be mounted on an existing wearable device. For example, in one embodiment device 70 is manufactured as a spectacles clip which can be mounted on the user's spectacles, in another embodiment, device 70 is manufactured as a helmet accessory which can be mounted on a helmet's screen.

Reference is now made to FIGS. 11a-c which illustrate a wearable device 110 in a preferred embodiment in which spectacles are used. According to the presently preferred embodiment of the invention device 110 comprises a spectacles body 112, having a housing 114, for holding image generating system 21 (not shown, see FIG. 10); a bridge 122 having a pair of nose clips 118, adapted to engage the user's nose; and rearward extending arms 116 adapted to engage the user's ears. Optical relay device 70 is preferably mounted between housing 114 and bridge 122, such that when the user wears device 110, element 17 is placed in front of first eye 25, and element 15 is placed in front of second eye 30. According to a preferred embodiment of the present invention device 110 comprises a one or more earphones 119 which can be supplied as separate units or be integrated with arms 116.

Interface 123 (not explicitly shown in FIGS. 11a-c) can be located in housing 114 or any other part of body 112. In embodiments in which decoder 33 is employed, decoder 33 can be mounted on body 112 or supplied as a separate unit as desired. Communication between data source 25 and interface 123 can be, as stated, wireless, in which case no physical connection is required between wearable device 110 and data source 25. In embodiments in which the communication is not wireless, suitable communication wires and/or optical fibers 120 are used to connect interface 123 with data source 25 and the other components of system 100.

The present embodiments can also be provided as add-ons to the data source or any other device capable of transmitting imagery data. Additionally, the present embodiments can also be used as a kit which includes the data source, the image generating system, the binocular device and optionally the wearable device. For example, when the data source is a communication device, the present embodiments can be used as a communication kit.

Additional objects, advantages and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds support in the following examples.

### EXAMPLES

Reference is now made to the following examples, which together with the above descriptions illustrate the invention in a non limiting fashion.

### Example 1

### Non-Uniform Duty Cycle

FIGS. 12a-d show numerical calculations of the diffraction efficiency of a grating as a function of the duty cycle, for impinging angles φ_{iy} of 50° (FIGS. 12a-b) and 55° (FIGS. 12c-d), and modulation depths 6 of 150 nm (FIGS. 12a and 12c) and 300 nm (FIGS. 12b and 12d). The different curves in FIGS. 12a-d correspond to wavelengths of 480 nm (solid line), 540 nm (dashed line) and 600 nm (dot-dash line). The calculations were based on the Maxwell equations, for 455 nm period grating formed in a light transmissive substrate having index of refraction of 1.53.

### Example 2

### Non-uniform Modulation Depth

FIGS. 13a-b show numerical calculations of the diffraction efficiency of a grating as a function of the modulation depth δ, for impinging angles φ_{iy} of 50° (FIG. 13a) and 55° (FIG. 13b), and duty cycle of 0.5. The different curves in FIGS. 13a-b correspond to wavelengths of 480 nm (solid line), 540 nm (dashed line) and 600 nm (dot-dash line). The calculations were based on the Maxwell equations, for 455 nm period grating formed in a light transmissive substrate having index of refraction of 1.53.

As shown in FIGS. 13-a-b, the diffraction efficiency increases with increasing δ up to modulation depth of about 200-250 nm. Above about 250 nm, the diffraction efficiency decreases with increasing δ up to modulation depth of about 400-500 nm.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A diffractive optical element, comprising a grating having a periodic linear structure in at least one direction, said linear structure being characterized by non-uniform duty cycle selected such that said grating is described by non-uniform diffraction efficiency function;
wherein said non-uniform diffraction efficiency function is selected such that when a light ray impinges on said grating a plurality of times, a predetermined and substantially constant fraction of the energy of said light is diffracted at each impingement, and a light beam having a substantially uniform intensity profile for a predetermined range of wavelengths is provided.

2. An optical relay device, comprising a light transmissive substrate and a plurality of diffractive optical elements, wherein at least one diffractive optical element of said plurality of diffractive optical elements is the diffractive optical element of claim 1.

3. A system for providing an image to a user, comprising the optical relay device of claim 2, and an image generating system for providing said optical relay device with collimated light constituting said image.

4. A method of diffracting light, comprising entrapping the light to propagate through a light transmissive substrate via total internal reflection, and using a diffractive optical element for diffracting the light out of said light transmissive substrate,
wherein said diffractive optical element comprises a grating having a periodic linear structure in at least one direction, said linear structure being characterized by non-uniform duty cycle selected such that said grating is described by non-uniform diffraction efficiency function;
wherein said non-uniform diffraction efficiency function is selected such that when a light ray impinges on said grating a plurality of times, a predetermined and substantially constant fraction of the energy of said light is diffracted at each impingement, and a light beam having a substantially uniform intensity profile for a predetermined range of wavelengths is provided.

5. The element of claim 1, wherein said linear structure is further characterized by non-uniform modulation depth selected in combination with said non-uniform duty cycle to provide said non-uniform diffraction efficiency function.

6. The element of claim 1, wherein said predetermined range of wavelengths extends from about 0.7λ to about 1.3λ, wherein λ is a central value characterizing the said range.

7. The device of claim 2, wherein at least one grating of said plurality of diffractive optical elements is formed in said light transmissive substrate.

8. The device of claim 2, wherein at least one grating of said plurality of diffractive optical elements is attached to said light transmissive substrate.

9. The device of claim 2, wherein said plurality of diffractive optical elements comprises an input diffractive optical element, a first output diffractive optical element and a second output diffractive optical element.

10. The device of claim 9, wherein said input diffractive optical element is designed and constructed for diffracting light striking the device at a plurality of angles within a predetermined field-of-view into said substrate, such that light corresponding to a first partial field-of-view propagates via total internal reflection to impinge on said first output diffractive optical element, and light corresponding to a second partial field-of-view propagates via total internal reflection to impinge on said second output diffractive optical element, said first partial field-of-view being different from said second partial field-of-view.

11. The system of claim 3, wherein said image generating system comprises a light source, at least one image carrier and a collimator for collimating light produced by said light source and reflected or transmitted through said at least one image carrier.

12. The system of claim 3, wherein said image generating system comprises at least one miniature display and a collimator for collimating light produced by said at least one miniature display.

13. The system of claim 3, wherein said image generating system comprises a light source, configured to produce light modulated imagery data, and a scanning device for scanning said light modulated imagery data onto the optical relay device.
